(19) United States
(12) Patent Application Publication
(10) Pub. No.: US 2013/0083074 A1
(43) Pub. Date: Apr. 4, 2013

(54) METHODS, APPARATUSES AND COMPUTER PROGRAM PRODUCTS UTILIZING HOVERING, IN PART, TO DETERMINE USER INTERFACE ORIENTATION

(71) Applicants: Mikko Antero Nurmi, Tampere (FI); Jari Olavi Saukko, Tampere (FI)

(72) Inventors: Mikko Antero Nurmi, Tampere (FI); Jari Olavi Saukko, Tampere (FI)

(73) Assignee: Nokia Corporation, Espoo (FI)

(21) Appl. No.: 13/251,610

(22) Filed: Oct. 3, 2011

(51) Int. Cl. G09G 5/00

(52) U.S. Cl. 345/650

(57) ABSTRACT

An apparatus for providing a user-friendly and reliable manner for orienting a user interface may include a processor and memory storing executable computer program code that cause the apparatus to at least perform operations including detecting at least one pointer in association with one or more portions of a display. The computer program code may further cause the apparatus to determine a location(s) of the pointer in relation to a user interface and analyze data of an image of the pointer at the location corresponding to the user interface to determine an orientation of a user in relation to the user interface. The computer program code may further cause the apparatus to orient the user interface to display the user interface in an orientation that matches or corresponds to the determined orientation of the user in relation to the user interface. Corresponding methods and computer program products are also provided.

### TECHNOLOGICAL FIELD

An example embodiment of the invention relates generally to user interface technology and, more particularly, relates to a method, apparatus, and computer program product for utilizing hovering information in part to determine the orientation of a user interface.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase convenience to users relates to improving a user's ability to effectively interface with the user's communication device. Accordingly, numerous user interface mechanisms have been developed to attempt to enable a user to more easily accomplish tasks or otherwise improve the user's experience in using the device. In this regard, for example, a user's experience during certain applications such as, for example, web browsing or applications that enable user interaction may be enhanced by using a touch screen display as the user interface.

At present, many communication devices may automatically adjust user interface screen orientation for display of items of data on behalf of a user. Currently, communication devices typically use gravitation and motion sensors to automatically adjust a user interface screen for display by a user. For example, existing communication devices may rotate the user interface in a particular orientation based on a detected gravitation or motion. A drawback of this approach is that the communication device may be unaware of the orientation of the communication device in relation to a user holding the communication device. As such, in an instance in which a user holds the communication device, the gravitation and motion sensors may provide the display of the user interface in an orientation that is undesirable to the user. For instance, the user may desire the display of the user interface in a portrait format or a landscape format depending on the orientation of the user. Providing the display of the user interface in an undesirable orientation may be burdensome to the user and may result in user dissatisfaction since the user may need to manually reorient the user interface in a desired orientation.

In view of the foregoing drawbacks, it may be desirable to provide an alternative mechanism in which to enable orientation of a user interface.

### BRIEF SUMMARY

A method, apparatus and computer program product are therefore provided for enabling provision of a user interface in an orientation associated with a user utilizing the user interface. For instance, an example embodiment may utilize hovering information, in part, to detect one or more pointers (e.g., fingers, hands, pointing devices (e.g., a stylus, a pen, etc.)) or the like above a screen (e.g., a touch screen) of a communication device and may analyze the information to determine the orientation in which a user may be holding the communication device.

In this regard, an example embodiment may rotate or orient a user interface such that the user interface matches the detected manner in which the user may be holding the communication device. In an example embodiment, the communication device(s) may detect the pointer(s) (e.g., finger(s), hand(s), pointing device(s)) (e.g., hovering above) or around a screen/screen edges of a display by taking a three dimensional (3D) image(s) (e.g., a capacitive image(s)) of the pointer(s) (e.g., finger(s), hand(s), pointing device(s)). Based in part on the orientation of the detected pointer(s) (e.g., finger(s), hand(s), pointing device(s)), an example embodiment may enable provision of display of the user interface in the orientation that matches or corresponds to the detected orientation of user in relation to the user interface.

In one example embodiment, a method for efficiently and reliably orienting a user interface of an apparatus is provided. The method may include detecting at least one pointer in association with one or more portions of a display and determining at least one location of the pointer in relation to a user interface. The method may further include analyzing data of a captured image of the pointer at the location corresponding to the user interface to determine an orientation of a user in relation to the user interface. The method may further include orienting the user interface to enable display of the user interface in an orientation that matches or corresponds to the determined orientation of the user in relation to the user interface.

In another example embodiment, an apparatus for efficiently and reliably orienting a user interface of an apparatus is provided. The apparatus may include a processor and a memory including computer program code. The memory and the computer program code are configured to, with the processor, cause the apparatus to at least perform operations including detecting at least one pointer in association with one or more portions of a display and determining at least one location of the pointer in relation to a user interface. The memory and the computer program code may further cause the apparatus to analyze data of a captured image of the pointer at the location corresponding to the user interface to determine an orientation of a user in relation to the user interface. The memory and the computer program code may further cause the apparatus to orient the user interface to enable display of the user interface in an orientation that matches or corresponds to the determined orientation of the user in relation to the user interface.

In another example embodiment, a computer program product for efficiently and reliably orienting a user interface of an apparatus is provided. The computer program product includes at least one computer-readable storage medium having computer-executable program code instructions stored therein. The computer executable program code instructions may include program code instructions configured to facilitate detection of at least one pointer in association with one or more portions of a display and determine at least one location of the pointer in relation to a user interface. The program code instructions may also analyze data of a captured image of the pointer at the location corresponding to the user interface to determine an orientation of a user in relation to the user interface. The program code instructions may also orient the user interface to enable display of the user interface in an orientation that matches or corresponds to the determined orientation of the user in relation to the user interface.

An example embodiment of the invention may provide a better user experience given the ease and efficiency in providing a user interface in a desirable orientation. As a result, device users may enjoy improved capabilities with respect to applications and services accessible via the device.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is a diagram illustrating orientation of a user interface of an apparatus by hovering a touch screen according to an example embodiment of the invention;

FIG. 4 is a diagram illustrating orientation of a user interface of another apparatus according to an example embodiment of the invention;

FIG. 5 is a diagram illustrating an apparatus determining orientations of multiple user interfaces according to an example embodiment of the invention;

FIG. 6 is a diagram illustrating approaches for performing 3D space monitoring by an apparatus of one or more pointers according to an example embodiment of the invention;

FIG. 7 is a diagram illustrating a 3D space for monitoring around an apparatus according to an example embodiment of the invention; and

FIG. 8 illustrates a flowchart for utilizing hovering, in part, to define orientation of a user interface according to an example embodiment of the invention.

### DETAILED DESCRIPTION

Some embodiments of the invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a pointer(s) may include, but is not limited to, one or more body parts such as, for example, a finger(s), a hand(s) etc., or a mechanical and/or electronic pointing device(s) (e.g., a stylus, pen, mouse, joystick, etc.) configured to enable a user(s) to input items of data to a communication device.

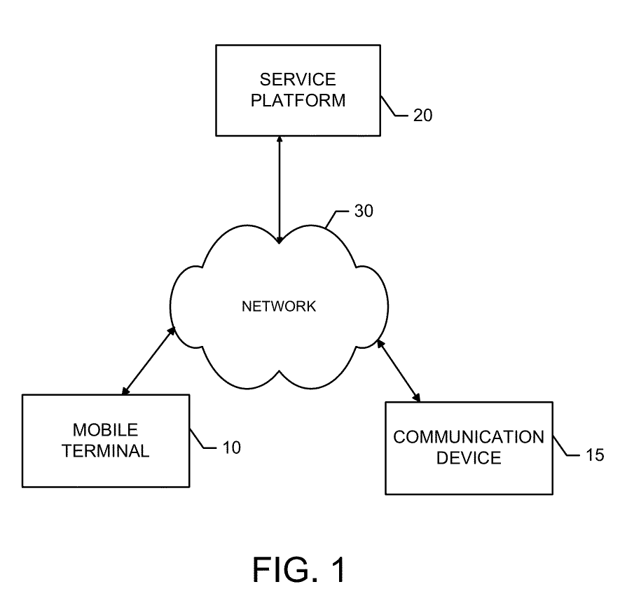

FIG. 1 illustrates a block diagram of a system that may benefit from an embodiment of the invention. It should be understood, however, that the system as illustrated and hereinafter described is merely illustrative of one system that may benefit from an example embodiment of the invention and, therefore, should not be taken to limit the scope of embodiments of the invention. As shown in FIG. 1, an embodiment of a system in accordance with an example embodiment of the invention may include a mobile terminal 10 capable of communication with numerous other devices including, for example, a service platform 20 via a network 30. In one embodiment of the invention, the system may further include one or more additional communication devices (e.g., communication device 15) such as other mobile terminals, personal computers (PCs), servers, network hard disks, file storage servers, and/or the like, that are capable of communication with the mobile terminal 10 and accessible by the service platform 20. However, not all systems that employ an embodiment of the invention may comprise all the devices illustrated and/or described herein. Moreover, in some cases, an embodiment may be practiced on a standalone device independent of any system.

The mobile terminal 10 may be any of multiple types of mobile communication and/or computing devices such as, for example, tablets (e.g., tablet computing devices), portable digital assistants (PDAs), pagers, mobile televisions, mobile telephones, gaming devices, wearable devices, head mounted devices, laptop computers, touch surface devices, cameras, camera phones, video recorders, audio/video players, radios, global positioning system (GPS) devices, or any combination of the aforementioned, and other types of voice and text communications systems. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30.

Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), LTE advanced (LTE-A) and/or the like. Thus, the network 30 may be a cellular network, a mobile network and/or a data network, such as a Local Area Network (LAN), a Metropolitan Area Network (MAN), and/or a Wide Area Network (WAN), e.g., the Internet. In turn, other devices such as processing elements (e.g., personal computers, server computers or the like) may be included in or coupled to the network 30. By directly or indirectly connecting the mobile terminal 10 and the other devices (e.g., service platform 20, or other mobile terminals or devices such as the communication device 15) to the network 30, the mobile terminal 10 and/or the other devices may be enabled to communicate with each other, for example, according to numerous communication protocols, to thereby carry out various communication or other functions of the mobile terminal 10 and the other devices, respectively. As such, the mobile terminal 10 and the other devices may be enabled to communicate with the network 30 and/or each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as Wireless LAN (WLAN), Worldwide Interoperability for Microwave Access (WiMAX), WiFi, Ultra-Wide Band (UWB), Wibree techniques and/or the like and fixed access mechanisms such as Digital Subscriber Line (DSL), cable modems, Ethernet and/or the like.

In an example embodiment, the service platform 20 may be a device or node such as a server or other processing element. The service platform 20 may have any number of functions or associations with various services. As such, for example, the service platform 20 may be a platform such as a dedicated server (or server bank) associated with a particular information source or service (e.g., a service associated with sharing user interface settings), or the service platform 20 may be a backend server associated with one or more other functions or services. As such, the service platform 20 represents a potential host for a plurality of different services or information sources. In one embodiment, the functionality of the service platform 20 is provided by hardware and/or software components configured to operate in accordance with known techniques for the provision of information to users of communication devices. However, at least some of the functionality provided by the service platform 20 may be data processing and/or service provision functionality provided in accordance with an example embodiment of the invention.

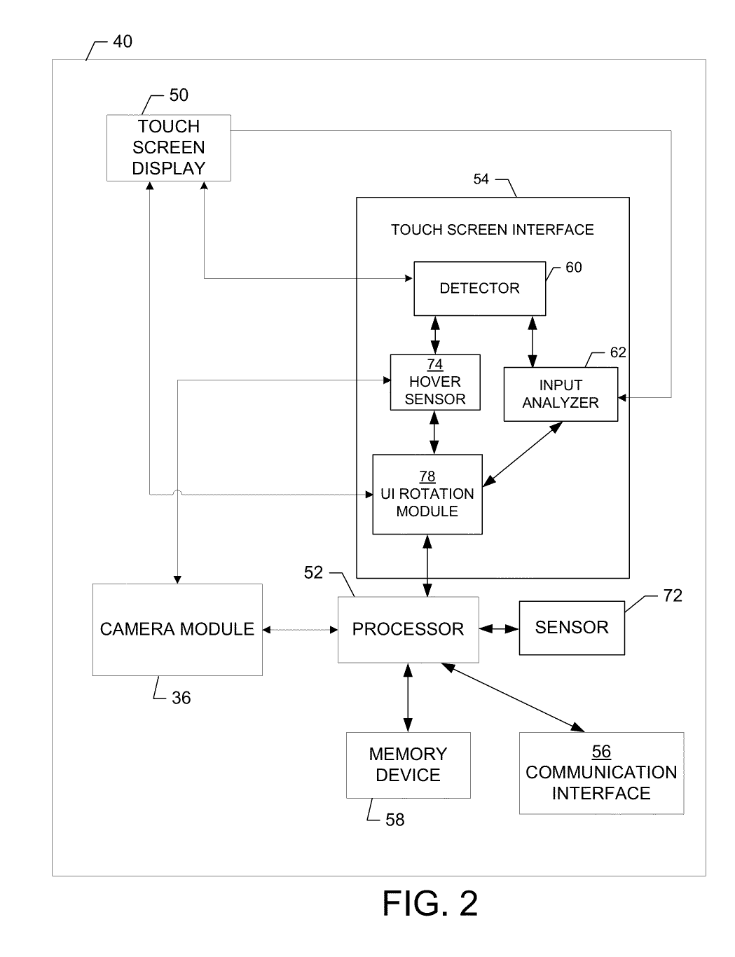

In an example embodiment, the mobile terminal 10 may employ an apparatus (e.g., the apparatus of FIG. 2) capable of employing an embodiment of the invention. Moreover, the communication device 15 may also implement an embodiment of the invention.

FIG. 2 illustrates a schematic block diagram of an apparatus for employing a user-friendly input interface in communication with a touch screen display that enables efficient orientation of the input interface based in part on an orientation of a user according to an example embodiment of the invention. An example embodiment of the invention will now be described with reference to FIG. 2, in which certain elements of an apparatus 40 are displayed. The apparatus 40 of FIG. 2 may be employed, for example, on the mobile terminal 10 (and/or the communication device 15). Alternatively, the apparatus 40 may be embodied on a network device of the network 30. However, the apparatus 40 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 40 may include or otherwise be in communication with a touch screen display 50 (also referred to herein as display 50), a processor 52, a touch screen interface 54, a communication interface 56, a memory device 58, a camera module 36 and a sensor 72. In some example embodiments, the touch screen display 50 and the touch screen interface 54 may be separate devices. In some alternative example embodiments, the touch screen display 50 may embody the touch screen interface 54 and may be a single device. The touch screen interface 54 may include a detector 60, an input analyzer 62, a hover sensor 74 and a user interface (UI) rotation module 78. The memory device 58 may include, for example, volatile and/or non-volatile memory. For example, the memory device 58 may be an electronic storage device (e.g., a computer readable storage medium) comprising gates configured to store data (e.g., bits) that may be retrievable by a machine (e.g., a computing device like processor 52). In an example embodiment, the memory device 58 may be a tangible memory device that is not transitory. The memory device 58 may be configured to store information, data, files, applications, instructions or the like for enabling the apparatus to carry out various functions in accordance with an example embodiment of the invention. For example, the memory device 58 could be configured to buffer input data for processing by the processor 52. Additionally or alternatively, the memory device 58 could be configured to store instructions for execution by the processor 52. As yet another alternative, the memory device 58 may be one of a plurality of databases that store information and/or media content (e.g., pictures, videos, etc.).

The apparatus 40 may, in one embodiment, be a mobile terminal (e.g., mobile terminal 10) or a fixed communication device or computing device configured to employ an example embodiment of the invention. However, in one embodiment, the apparatus 40 may be embodied as a chip or chip set. In other words, the apparatus 40 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 40 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 52 may be embodied in a number of different ways. For example, the processor 52 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 52 may be configured to execute instructions stored in the memory device 58 or otherwise accessible to the processor 52. As such, whether configured by hardware or software methods, or by a combination thereof, the processor 52 may represent an entity (e.g., physically embodied in circuitry) capable of performing operations according to an embodiment of the invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the algorithms and operations described herein when the instructions are executed. However, in some cases, the processor 52 may be a processor of a specific device (e.g., a mobile terminal or network device) adapted for employing an embodiment of the invention by further configuration of the processor 52 by instructions for performing the algorithms and operations described herein. The processor 52 may include, among other things, a clock, an arithmetic logic unit (ALU) and logic gates configured to support operation of the processor 52.

In an example embodiment, the processor 52 may be configured to operate a connectivity program, such as a browser, Web browser or the like. In this regard, the connectivity program may enable the apparatus 40 to transmit and receive Web content such as, for example, location-based content or any other suitable content, according to a Wireless Application Protocol (WAP), for example. It should be pointed out that the processor 52 may also be in communication with the touch screen display 50 and may instruct the display to illustrate any suitable information, data, content (e.g., media content) or the like.

Meanwhile, the communication interface 56 may be any means such as a device or circuitry embodied in either hardware, a computer program product, or a combination of hardware and software that is configured to receive and/or transmit data from/to a network and/or any other device or module in communication with the apparatus 40. In this regard, the communication interface 56 may include, for example, an antenna (or multiple antennas) and supporting hardware and/or software for enabling communications with a wireless communication network (e.g., network 30). In fixed environments, the communication interface 56 may alternatively or also support wired communication. As such, the communication interface 56 may include a communication modem and/or other hardware/software for supporting communication via cable, Digital Subscriber Line (DSL), Universal Serial Bus (USB), Ethernet, High-Definition Multimedia Interface (HDMI) or other mechanisms. Furthermore, the communication interface 56 may include hardware and/or software for supporting communication mechanisms such as Bluetooth, Infrared, Ultra-Wideband (UWB), WiFi and/or the like.

The apparatus 40 includes a media capturing element, such as camera module 36. The camera module 36 may include a camera, video and/or audio module, in communication with the processor 52 and the display 50. The camera module 36 may be any means for capturing an image, video and/or audio for storage, display or transmission. For example, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device (e.g., memory device 58) of the apparatus 40 stores instructions for execution by the processor 52 in the form of software necessary to create a digital image file from a captured image. In an example embodiment, the camera module 36 may further include a processing element such as a co-processor which assists the processor 52 in processing image data and an encoder and/or decoder for compressing and/or decompressing image data. The encoder and/or decoder may encode and/or decode according to a Joint Photographic Experts Group, (JPEG) standard format or another like format. In some cases, the camera module 36 may provide live image data to the display 50. In this regard, the camera module 36 may facilitate or provide a camera view to the display 50 to show live image data, still image data, video data, or any other suitable data. Moreover, in an example embodiment, the display 50 may be located on one side of the apparatus 40 and the camera module 36 may include a lens positioned on the opposite side of the apparatus 40 with respect to the display 50 to enable the camera module 36 to capture images on one side of the apparatus 40 and present a view of such images to the user positioned on the other side of the apparatus 40.

In an example embodiment, the camera module 36 may capture one or more 3D images (also referred to herein as 3D capacitive images) of one or more pointers (e.g., fingers, hands, pointing devices (e.g., styluses, pens)) hovering over, or in contact with, one or more portions of touch screen interface 54 or one or more edges of the touch screen display 50. In one example embodiment, the camera module 36 may be a heat camera configured to detect one or more pointers (e.g., fingers, hands, pointing devices or the like). The UI rotation module 78 may analyze the data of the 3D capacitive images to determine an orientation of a user of the apparatus 40 and may enable display, via the touch screen display 50, of the touch screen interface 54 in an orientation that matches or corresponds to the determined orientation of the user in relation to the user interface, as described more fully below.

The touch screen display 50 may be configured to enable touch recognition by any suitable technique, such as resistive, capacitive, infrared, strain gauge, surface wave, optical imaging, dispersive signal technology, acoustic pulse recognition, or other like techniques. The touch screen display 50 may also detect pointer (e.g., a finger, hand, pointing device (e.g., a stylus, a pen, etc.)) movements just above (e.g., hovering above) or around/near the edges of the touch screen display 50 even in an instance in which the pointer (e.g., finger(s), hand(s) or pointing device(s)) may not actually touch the touch screen of the display 50. The touch screen interface 54 may be in communication with the touch screen display 50 to receive indications of user inputs at the touch screen display 50 and to modify a response to such indications based on corresponding user actions that may be inferred or otherwise determined responsive to the indications. In this regard, the touch screen interface 54 may be any device or means embodied in either hardware, software, or a combination of hardware and software configured to perform the respective functions associated with the touch screen interface 54, as described below. In an example embodiment, the touch screen interface 54 may be embodied in software as instructions that are stored in the memory device 58 and executed by the processor 52. Alternatively, the touch screen interface 54 may be embodied as the processor 52 configured to perform the functions of the touch screen interface 54.

The touch screen interface 54 (also referred to herein as user interface 54) may be configured to receive an indication of an input in the form of a touch event, or a hover event, at the touch screen display 50. Following recognition of the touch event, the touch screen interface 54 may be configured to thereafter determine a stroke event or other input gesture and provide a corresponding indication on the touch screen display 50 based on the stroke event. In this regard, for example, the touch screen interface 54 may include a detector 60 to receive indications of user inputs in order to recognize and/or determine a touch event based on each input received at the detector 60.

In an example embodiment, one or more sensors (e.g., sensor 72) may be in communication with the detector 60. The sensors may be any of various devices or modules configured to sense one or more conditions. In this regard, for example, a condition(s) that may be monitored by the sensor 72 may include pressure (e.g., an amount of pressure exerted by a touch event) and any other suitable parameters (e.g., an amount of time in which the touch screen of the display 50 was pressed (e.g., a long press), or a size of an area of the touch screen of the display 50 that was pressed).

A touch event may be defined as a detection of an object or pointer, such as, for example, a stylus, finger, pen, pencil or any other pointing device, coming into contact with, or hovering above or around, a portion of the touch screen display in a manner sufficient to register as a touch (or registering of a detection of an object just above the touch screen display (e.g., hovering of a finger). In this regard, for example, a touch event could be a detection of pressure on the screen of touch screen display 50 above a particular pressure threshold over a given area. In one alternative embodiment, a touch event may be a detection of pressure on the screen of touch screen display 50 above a particular threshold time. Subsequent to each touch event, the touch screen interface 54 (e.g., via the detector 60) may be further configured to recognize and/or determine a corresponding stroke event or input gesture. A stroke event (which may also be referred to herein as an input gesture) may be defined as a touch event followed immediately by motion of the object initiating the touch event while the object remains in contact with the touch screen display 50. In other words, the stroke event or input gesture may be defined by motion following a touch event thereby forming a continuous, moving touch event defining a moving series of instantaneous touch positions. The stroke event or input gesture may represent a series of unbroken touch events, or in some cases a combination of separate touch events. For purposes of the description above, the term immediately should not necessarily be understood to correspond to a temporal limitation. Rather, the term immediately, while it may generally correspond to relatively short time after the touch event in many instances, instead is indicative of no intervening actions between the touch event and the motion of the object defining the touch positions while such object remains in contact with, or hovers above or around, the touch screen display 50. In this regard, it should be pointed out that no intervening actions cause operation or function of the touch screen. However, in some instances in which a touch event that is held for a threshold period of time triggers a corresponding function, the term immediately may also have a temporal component associated in that the motion of the object causing the touch event must occur before the expiration of the threshold period of time.

In an example embodiment, the detector 60 may be configured to communicate detection information regarding the recognition or detection of a stroke event or input gesture as well as a selection of one or more items of data (e.g., images, text, graphical elements, etc.) to an input analyzer 62 and the hover sensor 74. The input analyzer 62 may communicate with a UI rotation module 78. In one embodiment, the input analyzer 62 (along with the detector 60) may be a portion of the touch screen interface 54. In an example embodiment, the touch screen interface 54 may be embodied by a processor, controller of the like. Furthermore, the input analyzer 62 and the detector 60 may each be embodied as any means such as a device or circuitry embodied in hardware, software or a combination of hardware and software that is configured to perform corresponding functions of the input analyzer 62 and the detector 60, respectively.

The input analyzer 62 may be configured to compare an input gesture or stroke event to various profiles of previously received or predefined input gestures and/or stroke events in order to determine whether a particular input gesture or stroke event corresponds to a known or previously received input gesture or stroke event. If a correspondence is determined, the input analyzer may identify the recognized or determined input gesture or stroke event to the UI rotation module 78. In one embodiment, the input analyzer 62 is configured to determine stroke or line orientations (e.g., vertical, horizontal, diagonal, etc.) and various other stroke characteristics such as length, curvature, shape, and/or the like. The determined characteristics may be compared to characteristics of other input gestures either of this user or generic in nature, to determine or identify a particular input gesture or stroke event based on similarity to know input gestures.

The hover sensor 74 may receive detection information from the detector 60 and may communicate with the camera module 36 and the UI rotation module 78. The hover sensor 74 may be configured to communicate hover information regarding the recognition or detection of one or more hover events as well as a selection of one or more items of content (e.g., images, text, graphical elements, icons, etc.) to the UI rotation module 78 and/or the camera module 36. In an example embodiment, the hover sensor 74 may be embodied by a processor, controller of the like. In some example embodiments, the hover sensor 74 may be embodied as any means such as a device or circuitry embodied in hardware, software or a combination of hardware and software that is configured to perform corresponding functions of the hover sensor 74, as described herein. The hover sensor 74 may detect hovering of a pointer(s) (e.g., finger(s), hand(s), pointing device(s), etc.) within a predetermined proximity (e.g., 5 cm, etc.) above the touch screen display 50. Additionally, the hover sensor 74 may detect one or more pointers (e.g., fingers, hands, pointing devices), at one or more edges of the touch screen display 50. Moreover, in an example embodiment, the hover sensor 74 may detect one or more pointers (e.g., fingers, hands, pointing devices) behind the apparatus 40 or on one or more sides of the apparatus 40, as described more fully below.

In this regard, the detection, by the hover sensor 74, of the one or more pointers (e.g., fingers, hands, pointing devices) at the edges of the touch screen display 50 may be in response to detection of the pointers (e.g., fingers, pointing devices) in contact with a portion(s) of the edges or even in instances in which the pointers (e.g., fingers, hands, pointing devices) may not actually touch the edges of the touch screen display 50. The hover sensor 74 is configured to detect one or more pointers (e.g., fingers, hands, pointing devices) hovering or in contact with a portion of the touch screen display 50, in x, y and z directions of the touch screen display 50. Additionally, the hover sensor 74 may detect one or more pointers (e.g., fingers, hands, pointing devices) hovering or in contact with one or more edges of the touch screen display 50 in x, y, and z directions associated with the edges of the touch screen display 50.

In an example embodiment, the hover sensor 74 may detect a finger(s), hand(s) or another body part(s) in proximity of the touch screen interface 54 even in an instance in which the pointer(s) (e.g., finger(s), hand(s) or other body part(s)) is covered by clothes such as, for example, gloves, mittens or any other suitable item(s) of clothing.

The hover sensor 74 may detect hovering of a pointer(s) (e.g., finger(s), hand(s), pointing device(s)) and/or detection of the pointer(s) (e.g., finger(s), hand(s), pointing device(s)) in contact, or without contacting, the edges (e.g., within a predetermined proximity of an edge(s)) of the touch screen display 50 based in part on measuring capacitance. For example, the hover sensor 74 may detect the conductance of a pointer (e.g., a finger(s), hand(s) or a pointing device(s) (e.g., a capacitive stylus)) approaching or contacting a surface or area above the touch screen display 50, which may result in a distortion of an electrostatic field of the touch screen interface 54. The distortion in the electrostatic field may be measured by the hover sensor 74 as a change in capacitance. For instance, the hover sensor 74 may detect whether a pointer (e.g., finger(s), hand(s), pointing device) approaches or is removed from the touch screen interface 54 which may disrupt or interrupt an electrostatic field of the touch screen interface 54 and may change a capacitance. The change in capacitance may be measured by the hover sensor 74. Based in part on the detected or measured capacitance, the hover sensor 74 may determine the location(s) of a hover event(s) and/or a touch event(s) of a pointer(s) (e.g., finger(s), hand(s), pointing device(s)). In an alternative example embodiment, the hover sensor 74 may measure a change in capacitance of the touch screen interface 54 in an instance in which a pointer(s) (e.g., finger(s), hand(s), another human body part(s), pointing device(s)) approaches or is removed away from the touch screen interface 54 which may alter a current in the electrostatic field. The detection by the hover sensor 74 of the altered current in the electrostatic field may enable the hover sensor 74 to measure the corresponding capacitance of the touch screen interface 54 and determine the location(s) of a hover event(s) and/or a touch event(s).

The locations determined by the hover sensor 74, based on the locations of the hover event(s) and/or touch event(s), may trigger the hover sensor 74 to send a message(s) to the camera module 36. The message may include data instructing the camera module 36 to capture an image (e.g., a capacitive image (e.g., a 3D image)) of the pointer(s) (e.g., finger(s), hand(s), pointing device(s)) at a corresponding location(s) in association with the touch screen interface 54. The camera module 36 may provide, via the processor 52, the captured image to the UI rotation module 78 and the UI rotation module 78 may analyze the data of the image to determine an orientation of a user relative to the touch screen interface 54. In response to determining the orientation of the user in relation to the touch screen interface 54, the UI rotation module 78 may rotate or orient the display of touch screen interface 54, via the touch screen display 50, in an orientation that matches or corresponds to the determined orientation of the user relative to the touch screen interface 54, as described more fully below.

In an example embodiment, the hover sensor 74 may detect one or more pointers (e.g., hands, fingers, pointing devices) behind the apparatus 40 or on one or more sides of the apparatus 40 based in part on measuring a change in capacitance of an electrostatic field associated with the apparatus 40. Based in part on the measured capacitance, the hover sensor 74 may determine the location of a hover event(s) and/or a touch event(s) associated with the pointers (e.g., hands, fingers, pointing devices) behind the apparatus 40 or on one or more sides of the apparatus 40 and may utilize this location information to determine the manner in which the apparatus 40 is being held by a user to enable the UI rotation module 78 to determine the orientation of the touch screen interface 54 in relation to the user.

Additionally, the hover sensor 74 may detect one or more pointers (e.g., hands, fingers, pointing devices) behind the apparatus 40 or on one or more sides of the apparatus 40 based in part on measuring a change in capacitance of an electrostatic field associated with the apparatus 40. Based in part on the measured capacitance, the hover sensor 74 may determine the location of a hover event(s) and/or a touch event(s) associated with the pointers behind the apparatus 40 or on one or more sides of the apparatus 40 and may utilize this location information to determine the manner in which the apparatus 40 is being held by a user to enable the UI rotation module 78 to determine the orientation of the touch screen interface 54 in relation to the user.

In an example embodiment, the processor 52 may be embodied as, include or otherwise control the UI rotation module 78. The UI rotation module 78 may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or structure to perform the corresponding functions of the UI rotation module 78 as described below. Thus, in an example in which software is employed, a device or circuitry (e.g., the processor 52 in one example) executing the software forms the structure associated with such means.

The UI rotation module 78 may communicate with the hover sensor 74, the camera module 36, the input analyzer 62 and the processor 52. The camera module 36 may provide, via the processor 52, one or more captured images to the UI rotation module 78 in response to receipt of a message, by the camera module 36, from the hover sensor 74. The UI rotation module 78 may analyze the data of an image(s) to determine an orientation of a user relative to the touch screen interface 54. For example, the UI rotation module 78 may determine the orientation based in part on the manner in which the user is holding the apparatus 40 in relation to the touch screen interface 54.

In response to determining the orientation of the user in relation to the touch screen interface 54, the UI rotation module 78 may rotate or orient the display of touch screen interface 54, via the touch screen display 50, in an orientation (e.g., a portrait orientation, a landscape orientation, etc.) that matches or corresponds to the determined orientation (e.g., portrait orientation, landscape orientation, etc.) of the user relative to the touch screen interface 54, as described more fully below.

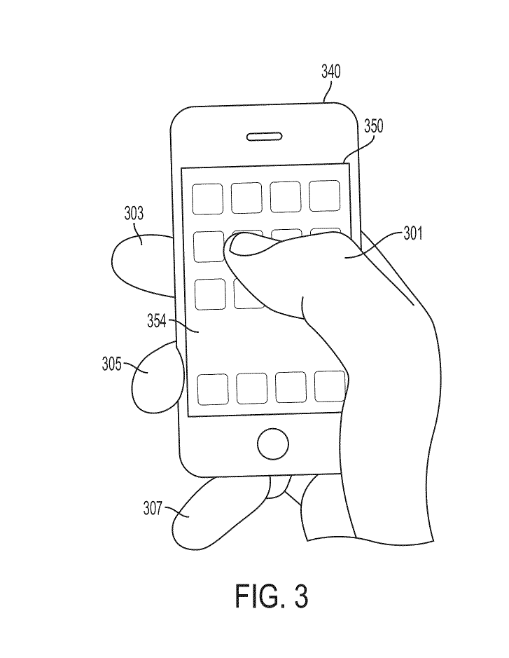

Referring now to FIG. 3, a diagram illustrating an apparatus determining an orientation of a user interface based in part on one or more detected hovering events is provided according to an example embodiment. In FIG. 3, a hover sensor (e.g., hover sensor 74) of the apparatus 340 (e.g., apparatus 40) may detect one or more hover events and/or one or more touch events. For instance, in the example embodiment of FIG. 3, the hover sensor may detect that a thumb 301 hovers over an item(s) of visible indicia (e.g., a graphical element (s) (e.g., an icon)). Additionally, the hover sensor of the apparatus 340 may detect one or more touch events at or near one or more edges of the touch screen display 350 (e.g., touch screen display 50). For instance, in this example embodiment, the hover sensor 74 may detect the fingers 303, 305, 307 touching the apparatus 340 near the edges of the touch screen display 350. The hover sensor of the apparatus 340 may detect the fingers 303, 305 and 307 by analyzing x, y, z directions near the edges of the touch screen display 350 for hover events and/or touch events.

The hover sensor (e.g., hover sensor 74) of the apparatus 340 may detect or determine the locations of the fingers 301, 303, 305, and 307 based on a measured capacitance associated with each of the fingers 301, 303, 305, and 307 in relation to an electrostatic field of the touch screen interface 354 (also referred to herein as user interface 354). In an example embodiment, the measured capacitance associated with the thumb 301 may be stronger or a higher value than measured capacitance values associated with fingers 303, 305, 307.

In response to detecting the hovering event(s) associated with thumb 301 and/or the touch events associated with fingers 303, 305, 307, the hover sensor of the apparatus 340 may send a message to a camera module (e.g., camera module 36) of the apparatus 340 and may instruct the camera module to capture an image of the thumb 301 and the fingers 303, 305, 307 at corresponding detected locations in relation to the touch screen interface 354. In response to receipt of the message, the camera module may capture the image (e.g., a 3D image (e.g., a 3D capacitive image)) and may send the image to a UI rotation module (e.g., UI rotation module 78) of the apparatus 340. The UI rotation module of the apparatus 340 may analyze the data of the captured image and may determine an orientation of a user of the apparatus 340 in relation to the touch screen interface 354. In this regard, the UI rotation module 78 may rotate or orient the display of the touch screen interface 354, via the touch screen display 350, to match or correspond to the determined orientation of the user in relation to the touch screen interface 354.

For purposes of illustration and not of limitation, consider that the UI rotation module of the apparatus 340 analyzed the data of the captured image provided by the camera module and determined that the orientation of the user in relation to the touch screen interface 354 is in a portrait orientation, for example. In this regard, for example, the UI rotation module of the apparatus 40 may orient the display, or enable display, of the touch screen interface 354, via the touch screen display 350 in the portrait orientation which matches the determined orientation of the user in relation to the touch screen interface 354. In an example embodiment, the UI rotation module 78 may utilize a predetermined threshold time to prevent the orientation of the touch screen interface 54 from changing more frequently than desired such as, for example, before the expiration of the predetermined threshold time.

The UI rotation module of the apparatus 340 may enable the orientation of the touch screen interface 354 provided, by the UI rotation module, to the touch screen display 350 to remain stable even in instances in which a user of the apparatus 340 moves (e.g., walks with) the apparatus 340. In this regard, for example, even in instances in which the user walks with the apparatus 50, the UI rotation module of the apparatus 340 may not rotate or reorient the orientation of the touch screen interface 354, via the touch screen display 350, until the hover sensor receives an indication of a subsequent detection of a pointer(s) (e.g., finger(s), hand(s), pointing device(s)) hovering over, or in contact with, one or more portions of the touch screen display 350 or one or more edges of the touch screen display 350.

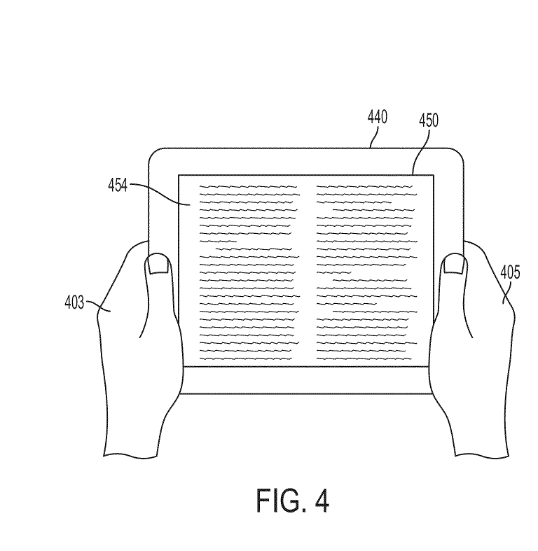

Referring now to FIG. 4, a diagram illustrating an apparatus determining an orientation of a user interface according to an example embodiment is provided. In FIG. 4, a hover sensor (e.g., hover sensor 74) of an apparatus 440 (e.g., apparatus 40) may detect the hands 403, 405 of a user in contact with the edges of the touch screen display 450 of the apparatus 440. In this regard, the hover sensor may determine the locations of the hands 403, 405 at the edges of the touch screen display 450. The hover sensor of the apparatus 440 may determine the locations of the hands 403, 405 based in part on measured capacitance of each hand 403, 405 in relation to an electrostatic field of the touch screen interface 454.

In response to determining the locations of the hands 403, 405, the hover sensor of the apparatus 440 may send a message or request to a camera module (e.g., camera module 36) of the apparatus 440 requesting the camera module to capture an image of the hands 403, 405 at the determined locations in relation to the touch screen interface 454. The camera module of the apparatus 440 may provide the captured image (e.g., a 3D image (e.g., a capacitive 3D image)) to the UI rotation module of the apparatus 440, in response to receipt of the message/request. As such, the UI rotation module may analyze the data associated with the captured image upon receipt of the image. In this regard, the UI rotation module of the apparatus 440 may determine the orientation (e.g., a landscape orientation, etc.) of the user of the apparatus 440 in relation to the touch screen interface 454 and may orient or rotate the display of the touch screen interface 454, via the touch screen display 450, to match or correspond to the orientation (e.g., landscape orientation, etc.) of the user in relation to the touch screen interface 454.

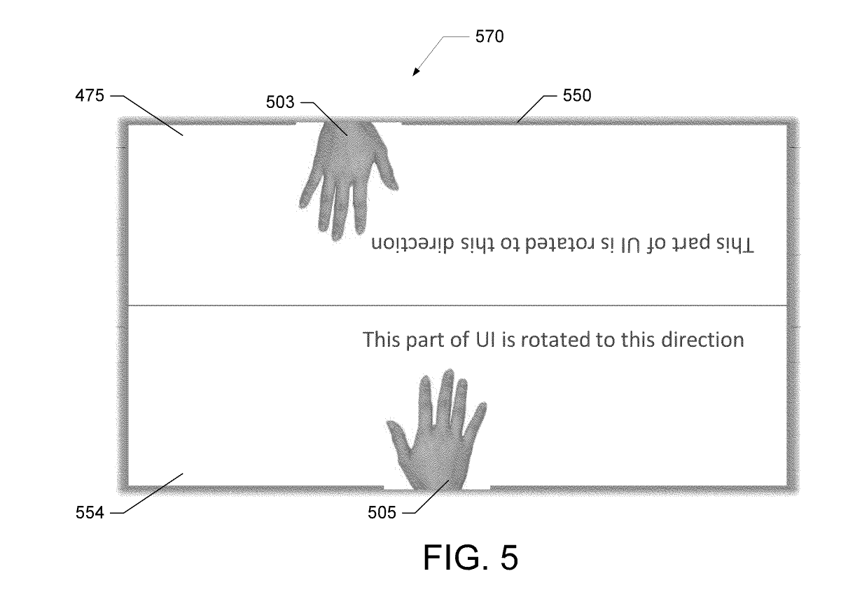

Referring now to FIG. 5, a diagram illustrating an apparatus determining orientations of multiple user interfaces according to an example embodiment is provided. In the example embodiment of FIG. 5, a large touch screen surface 550 (also referred to herein as touch screen display 550) (e.g., touch screen display 50 (e.g., a touch table)) of an apparatus 570 (e.g., apparatus 40) is provided. The touch screen surface 550 may include multiple touch screen interfaces such as, for example, a touch screen interface 475 (e.g., touch screen interface 54) and a touch screen interface 554 (e.g., touch screen interface 54). In the example embodiment of FIG. 5, a hover sensor (e.g., hover sensor 74) may detect hands 503, 505 or any other suitable pointers (e.g., fingers, styluses, pens, etc.) in contact with or hovering over the touch screen interfaces 475, 545. In this regard, the hover sensor may detect the location of the hands 503, 505 and may provide the corresponding location information to a UI rotation module (e.g., UI rotation module 78). As such, the UI rotation module may orient the touch screen interface 475 in relation to the hand 503 of a first user (e.g., User A) for display via the touch screen surface 550 and may orient the touch screen interface 554 for display via the touch screen surface 550 in relation to the hand 505 of a second user (e.g., User B). Although the example embodiment of FIG. 5 shows one hand 503 in contact with the touch screen interface 475 and one hand 505 in contact with the touch screen interface 554, it should be pointed out that any number of pointers (e.g., hands, fingers, pointing devices, etc.) in contact with or hovering over the touch screen interfaces 475, 554 may be detected by the hover sensor without departing from the spirit and scope of the invention.

In an alternative example embodiment, division of content of the touch screen surface 550 may not be strict in all instances. For instance, in this alternative example embodiment, the touch screen interfaces 475, 554 may be embodied as a single touch screen interface. In this regard, certain parts of the touch screen interface 475, 554 may be rotated by the UI rotation module based in part on detection of the positions/locations of pointers (e.g., one or more fingers, hands, pointing devices). For example, in one embodiment, content of the single touch screen interface (e.g., the combined touch screen interfaces 475, 545) and the direction of the single touch screen interface may be common for an entire surface area of the touch screen surface 550. However, virtual text input areas may be displayed for example, via touch screen surface 550, to two users utilizing the apparatus 570 in different orientations. For purposes of illustration and not of limitation, User A's virtual keyboard may be in a right orientation in front of User A and User B's virtual keyboard may also be in a right orientation on the other side of the touch screen surface 550.

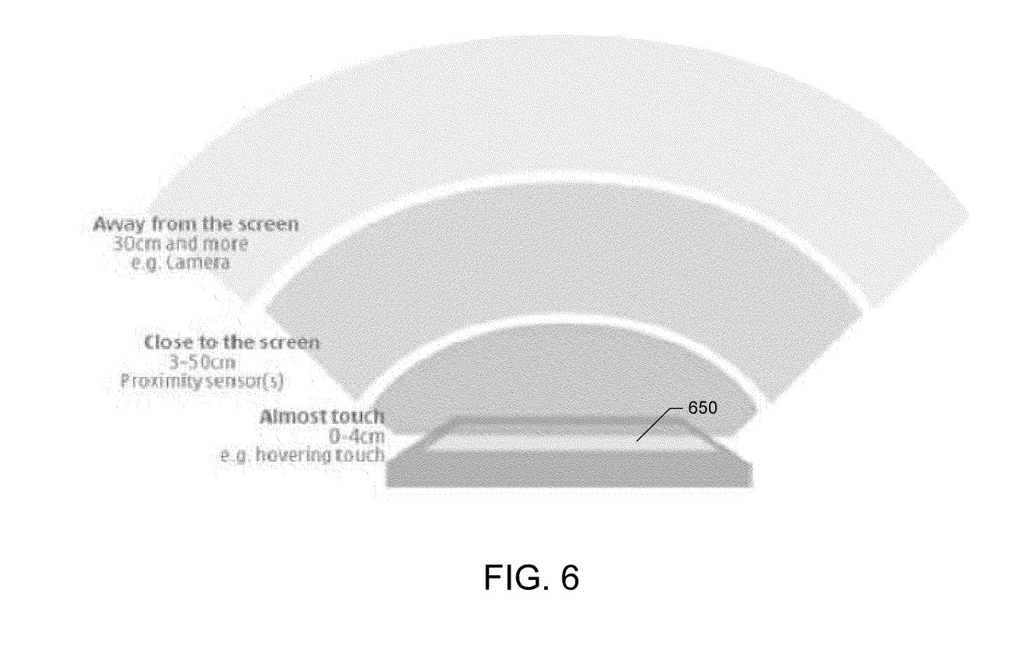

Referring now to FIG. 6, a diagram illustrating approaches for performing 3D space monitoring by an apparatus of one or more pointers according to an example embodiment is provided. In the example embodiment of FIG. 6, the camera module (e.g., camera module 36) of an apparatus (e.g., apparatus 40) may detect one or more pointers (e.g., finger(s), hand(s), pointing devices, etc.) a first predetermined distance (e.g., 30 cm or more) from a touch display screen 650 (e.g., touch screen display 50). Additionally, a proximity sensor (e.g., detector 60) of an apparatus (e.g., apparatus 40) may detect one or more pointers (e.g., finger(s), hand(s), pointing devices, etc.) a second predetermined distance (e.g., 3-50 cm or more) away from the touch display screen 650. A hover sensor (e.g., hover sensor 74) of an apparatus (e.g., apparatus 40) may detect one or more pointers (e.g., finger(s), hand(s), pointing devices, etc.) a third predetermined distance (e.g., 0-4 cm) from a touch screen display 650. In this example embodiment, the pointer(s) may be hovering within a predetermined distance (e.g., 0-4 cm) of the touch screen display 650. Based in part on the usage of the various technologies (e.g., a hover sensor (e.g., hover sensor 74), a proximity sensor (e.g., detector 60), and a camera module (e.g., camera module 36)) to detect pointers in association with the touch screen display 650, an apparatus (e.g., apparatus 40) of an example embodiment may utilize multiple 3D space monitoring technologies to detect the locations of the pointer(s) within predetermined distances away from the touch screen display 650.

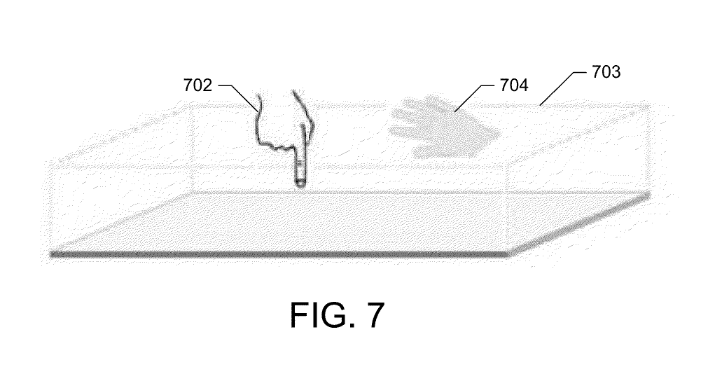

Referring now to FIG. 7, a diagram illustrating a 3D space for monitoring around an apparatus according to an example embodiment is provided. In the example embodiment of FIG. 7, a 3D area(s)/space(s) may be monitored by one or more of the 3D space monitoring technologies for detection of a pointer(s) (e.g., hand 702, hand 704). The 3D area(s)/space(s) may be defined by a box 703, point(s), hemisphere, etc., 360 degrees around an apparatus (e.g., apparatus 40).

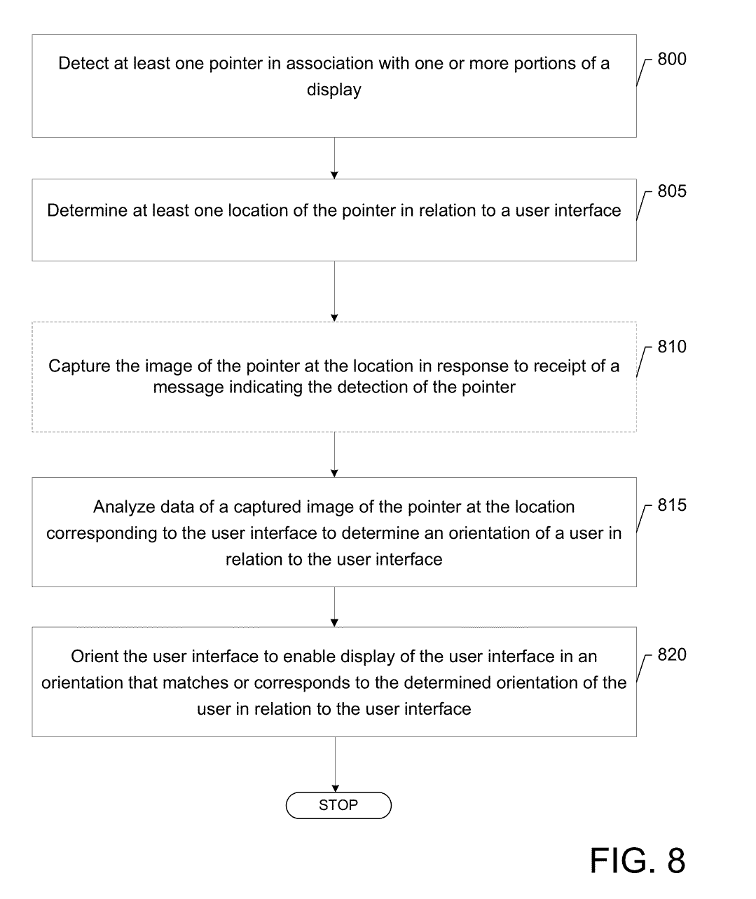

Referring now to FIG. 8, a flowchart for efficiently and reliably orienting a user interface of an apparatus according to an example embodiment is provided. At operation 800, an apparatus (e.g., hover sensor 74, detector 60, processor 52) may detect at least one pointer (e.g., a finger(s), a hand(s), a pointing device(s), etc.) in association with one or more portions of a display (e.g., touch screen display 50). At operation 805, an apparatus (e.g., hover sensor 74, processor 52) may determine at least one location of the pointer in relation to a user interface (e.g., touch screen interface 54). Optionally, at operation 810, an apparatus (e.g., camera module 36) may capture an image (e.g., a 3D image (e.g., a capacitive 3D image)) of the pointer at the location in response to receipt of a message indicating the detection of the pointer.

At operation 815, an apparatus (e.g., UI rotation module 78, processor 52) may analyze data of a captured image of the pointer at the location corresponding to the user interface to determine an orientation of a user in relation to the user interface. At operation 820, an apparatus (e.g., UI rotation module 78, processor 52) may orient the user interface to enable display of the user interface in an orientation that matches or corresponds to the determined orientation of the user in relation to the user interface.

It should be pointed out that FIG. 8 is a flowchart of a system, method and computer program product according to an example embodiment of the invention. It will be understood that each block of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 58) and executed by a processor (e.g., processor 52, UI rotation module 78, hover sensor 74). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In an example embodiment, an apparatus for performing the method of FIG. 8 above may comprise a processor (e.g., the processor 52, the UI rotation module 78, hover sensor 74) configured to perform some or each of the operations (800-820) described above. The processor may, for example, be configured to perform the operations (800-820) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (800-820) may comprise, for example, the processor 52 (e.g., as means for performing any of the operations described above), the UI rotation module 78, the hover sensor 74 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
detecting at least one pointer in association with one or more portions of a display;
determining at least one location of the pointer in relation to a user interface;
analyzing data of a captured image of the pointer at the location corresponding to the user interface to determine an orientation of a user in relation to the user interface; and
orienting, via a processor, the user interface to enable display of the user interface in an orientation that matches or corresponds to the determined orientation of the user in relation to the user interface.

2. The method of claim 1, wherein detecting the at least one pointer further comprises at least one of detecting that the pointer hovers above visible indicia of the display, contacts at least one portion of the display, or is within a proximity of, or contacts, one or more edges of the display.

3. The method of claim 1, wherein prior to analyzing the data, the method further comprises capturing the image of the pointer at the location in response to receipt of a message indicating the detection of the pointer.

4. The method of claim 1, further comprising:
determining the location based in part on determining a capacitance corresponding to the pointer in association with an electrostatic field measured in relation to the user interface.

5. The method of claim 1, wherein detecting comprises analyzing data in three directions of the display or edges of the display to detect the pointer.

6. The method of claim 1, wherein the pointer comprises at least one of a finger, a hand, or a pointing device.

7. The method of claim 1, wherein orienting comprises rotating the user interface to match the determined orientation of the user in relation to the user interface.

8. The method of claim 1, further comprising:
maintaining the user interface in the matched orientation until receipt of an indication of a subsequent detection of the pointer in association with a portion of the display.

9. An apparatus comprising:
at least one processor; and
at least one memory including computer program code, the at least one memory and the computer program code configured to, with the at least one processor, cause the apparatus to perform at least the following:
detect at least one pointer in association with one or more portions of a display;
determine at least one location of the pointer in relation to a user interface;
analyze data of a captured image of the pointer at the location corresponding to the user interface to determine an orientation of a user in relation to the user interface; and
orient the user interface to enable display of the user interface in an orientation that matches or corresponds to the determined orientation of the user in relation to the user interface.

10. The apparatus of claim 9, wherein the at least one memory and the computer program code are further configured to, with the processor, cause the apparatus to:
detect the at least one pointer by at least one of detecting that the pointer hovers above visible indicia of the display, contacts at least one portion of the display, or is within a proximity of, or contacts, one or more edges of the display.

11. The apparatus of claim 9, wherein prior to analyze the data, the at least one memory and the computer program code are further configured to, with the processor, cause the apparatus to:
capture the image of the pointer at the location in response to receipt of a message indicating the detection of the pointer.

12. The apparatus of claim 9, wherein the at least one memory and the computer program code are further configured to, with the processor, cause the apparatus to:
determine the location based in part on determining a capacitance corresponding to the pointer in association with an electrostatic field measured in relation to the user interface.

13. The apparatus of claim 9, wherein the at least one memory and the computer program code are further configured to, with the processor, cause the apparatus to:
detect the pointer by analyzing data in three directions of the display or edges of the display.

14. The apparatus of claim 9, wherein the pointer comprises at least one of a finger, a hand, or a pointing device.

15. The apparatus of claim 9, wherein the at least one memory and the computer program code are further configured to, with the processor, cause the apparatus to:
orient the user interface by rotating the user interface to match the determined orientation of the user in relation to the user interface.

16. The apparatus of claim 9, wherein the at least one memory and the computer program code are further configured to, with the processor, cause the apparatus to:
maintain the user interface in the matched orientation until receipt of an indication of a subsequent detection of the pointer in association with a portion of the display.

17. A computer program product comprising at least one non-transitory computer-readable storage medium having computer-executable program code instructions stored therein, the computer-executable program code instructions comprising:
program code instructions configured to facilitate detection of at least one pointer in association with one or more portions of a display;
program code instructions configured to determine at least one location of the pointer in relation to a user interface;
program code instructions configured to analyze data of a captured image of the pointer at the location corresponding to the user interface to determine an orientation of a user in relation to the user interface; and
program code instructions configured to orient the user interface to enable display of the user interface in an orientation that matches or corresponds to the determined orientation of the user in relation to the user interface.

18. The computer program product of claim 17, further comprising:
program code instructions configured to detect the at least one pointer by at least one of detecting that the pointer hovers above visible indicia of the display, contacts at least one portion of the display, or is within a proximity of, or contacts, one or more edges of the display.

19. The computer program product of claim 17, wherein prior to analyze the data, the computer program product further comprises:
program code instructions configured to facilitate capture of the image of the pointer at the location in response to receipt of a message indicating the detection of the pointer.

20. The computer program product of claim 17, further comprising:
program code instructions configured to determine the location based in part on determining a capacitance corresponding to the pointer in association with an electrostatic field measured in relation to the user interface.
